(19) United States
(12) Patent Application Publication
(10) Pub. No.: US 2026/0368682 A1
(43) Pub. Date: Nov. 19, 2026

(54) METHOD AND SYSTEM FOR GENERATING SIMULATIONS

(71) Applicant: Honeywell International Inc., Charlotte, NC (US)

(72) Inventors: Rajesh Kulandaivel Sankarapandian, Cumming, GA (US); Jaya Hunasikatti, Bangalore (IN)

(21) Appl. No.: 19/207,369

(22) Filed: May 14, 2025

(51) Int. Cl. G06Q 10/067

(52) U.S. Cl. CPC G06Q 10/067; G06Q 10/0674

(57) ABSTRACT

The present disclosure relates to a method and system for generating simulation data based on receiving a user input to execute one or more simulation scenarios, where the user input includes at least one scenario description, and processing the at least one scenario description to determine user requirements. One or more parameters associated with the user requirements are determined. Further, at least one enterprise type associated with the user requirements is identified, where the enterprise type is identified based on at least one of, the scenario description, a user profile, or a predefined enterprise classification. The one or more parameters and the at least one enterprise type is provided to a GenAI engine, and the GenAI engine generates one or more data points corresponding to each enterprise type. The one or more data types generated are thereafter provided to a simulation engine for executing one or more simulations.

### TECHNICAL FIELD

The present disclosure relates to system and method for generating simulations, and particularly, relates to the system and method for generating data points for executing simulations corresponding to a user input.

### BACKGROUND

In modern enterprises and industrial establishments, there arise a need for simulating different operations of the enterprises or establishment, or simulation of different scenarios which may arise during operations performed in the enterprises, so as to determine optimization of assets within the enterprise. Further, implementing of simulations help predict the requirements that are to be met in case of abnormal incidents, and also helps analyse the impact of different decisions in the outcomes or productivity of operations, so as to determine the most appropriate steps to be adopted to optimise the operations of an enterprise or industry. The need for accurate, dynamic, and scalable simulation data for various operational scenarios is crucial for system testing, training, and predictive analysis. The simulation data plays an essential role in assessing and verifying system behaviour under different conditions, including normal operations, fault conditions, and exceptional circumstances, such as holidays or unique events.

Currently, there is a lack of efficient methods or systems for performing simulations that can dynamically provide outputs corresponding to varying scenarios or prompts, as the data points used for generating such simulations are time-consuming to create and configure. Generating a simulation based on modifying the input query, or based on a different query is difficult to implement as generating a corresponding set of data points for the simulation is a cumbersome process. Further, such data points may be generated by individuals who may not have access to relevant information or data pertaining to the operations for which the simulation is to be generated, thereby leading to generation of incorrect or inadequate data points, and subsequently, creation of an inaccurate simulation.

Traditionally, generating the simulation data involved manual configuration, real-world device connections, and significant computational resources. These traditional methods often require extensive effort and time to create relevant datasets that adequately represent different operational scenarios, limiting flexibility and responsiveness of systems in real-time operations. Furthermore, the dynamic nature of operational environments demands frequent updates to the simulation data to reflect changing conditions, further complicating the process and straining resources.

The challenge with existing methods is their inability to efficiently and autonomously generate diverse simulation data for a variety of operational scenarios in an adaptive and real-time manner. This results in inefficiencies, errors, and an inability to quickly respond to new demands or conditions. The reliance on manual processes and static datasets also contributes to high operational costs and delays in implementation.

Hence, there arises a need for a more flexible approach that can accommodate different simulation data requirements without manual reconfiguration or adjustments for each new scenario.

### SUMMARY OF THE INVENTION

In general, embodiments of the present disclosure herein provide a method and system for generating simulations. Other implementations will be, or will become, apparent to one with skill in the art upon examination of the following figures and detailed description. It is intended that all such additional implementations be included within this description be within the scope of the disclosure and be protected within the scope of the following claims.

In accordance with an embodiment of the present disclosure, a method of generating simulations is described. The method comprises receiving a user input to execute one or more simulation scenarios, where the user input includes at least one scenario description, and processing the at least one scenario description to determine user requirements. The method further comprises determining one or more parameters associated with the user requirements. Further still, the method comprises identifying at least one enterprise type associated with the user requirements, where the enterprise type is identified based on at least one of, the scenario description, a user profile, or a predefined enterprise classification. Thereafter, the method comprises providing the one or more parameters and the at least one identified enterprise type to a GenAI engine, and generating one or more data points based on each parameter corresponding to each identified enterprise type using the GenAI engine. The one or more data points generated by the GenAI engine is provided to a simulation engine for executing the one or more simulation scenarios.

In one aspect, the the one or more parameters includes at least one of type of data, role of data. In another aspect, the scenario description provided in the user input is processed by Natural Language Processing (NLP) technique.

In another aspect, the method further comprises accessing at least one knowledge database associated with the at least one identified enterprise type.

In another aspect, the method further comprises receiving at least one modification in the scenario description, identifying one or more modified parameters based on modification in the scenario description, and providing providing the one or more modified parameters and the at least one identified enterprise type to the GenAI engine.

In another aspect, the method further comprises selectively providing generated data points to the simulation engine based on user selection.

In another aspect, the method further comprises storing the one or more generated data points for the at least one identified enterprise type in a database. Further, the method also comprises identifying if the one or more data points associated with the one or more parameters is present in the database, and generating one or more additional data points, based on identification that the one or more data points are not present in the database.

The method further comprises accessing a channel inventory of the enterprise, where the channel inventory comprises details of each data channel of the plurality of data channels of the enterprise. The details of each data channel are stored such that the channel inventory has reference to the plurality of data systems of the enterprise. A second set of information is retrieved from the channel inventory, such that the second set of information comprises a channel name, the unique reference of the source data system, and a unique reference of the target data system. The method further comprises generating the unique signature of the data item based on processing of the first set of information and the second set of information, and storing the unique signature of the data item in a database.

In another embodiment of the present invention, a system for generating simulations is provided. The system comprises a processor and a memory coupled with the processor, wherein the memory stores program instructions configured to receive a user input to execute one or more simulation scenarios, where the user input includes at least one scenario description. Further, the program instructions are also configured to process the at least one scenario description to determine user requirements, and determine one or more parameters associated with the user requirements. Further still, the program instructions are configured to identify at least one enterprise type associated with the user requirements, where the enterprise type is identified based on at least one of, the scenario description, a user profile, or a predefined enterprise classification. The program instructions are further configured to provide the one or more parameters and the at least one identified enterprise type to a GenAI engine and generate, by the GenAI engine, one or more data points based on each parameter corresponding to each identified enterprise type. The program instructions are further configured to provide the one or more data points to a simulation engine for executing the one or more simulation scenarios.

In one aspect, the program instructions are further configured to access at least one knowledge database associated with the at least one identified enterprise type. In another aspect, the program instructions are further configured to selectively provide generated data points to the simulation engine based on user selection.

In another aspect, the program instructions are configured to receive at least one modification in the scenario description, identify at least one or more modified parameters based on modification in the scenario description, and provide the one or more modified parameters and the at least one identified enterprise type to the GenAI engine.

In another aspect, the program instructions are configured to store the one or more generated data points for the at least one identified enterprise type in a database. The program instructions are further configured to identify if the one or more data points associated with the one or more parameters is present in the database and generate one or more additional data points, based on identification that the one or more data points are not present in the database.

In yet another embodiment of the present invention, a non-transitory computer-readable storage medium is provided comprising computer program code for execution by one or more processors of an apparatus, the computer program code configured to receive a user input to execute one or more simulation scenarios, where the user input includes at least one scenario description and process the at least one scenario description to determine user requirements. The computer program code is further configured to determine one or more parameters associated with the user requirements. Further still, the computer program code is configured to identify at least one enterprise type associated with the user requirements, wherein the enterprise type is identified based on at least one of, the scenario description, a user profile, or a predefined enterprise classification. The computer program code is configured to provide the one or more parameters and the at least one identified enterprise type to a GenAI engine, and generate, by the GenAI engine, one or more data points based on each parameter corresponding to each identified enterprise type. The computer program code is further configured to provide the one or more data points to a simulation engine for executing the one or more simulation scenarios.

In one aspect, the computer program code is further configured to access at least one knowledge database associated with the at least one identified enterprise type. In another aspect, the computer program code is further configured to selectively provide generated data points to the simulation engine based on user selection.

In yet another aspect, the computer program code is configured to receive at least one modification in the scenario description, identify at least one or more modified parameters based on modification in the scenario description, and provide the one or more modified parameters and the at least one identified enterprise type to the GenAI engine.

### BRIEF DESCRIPTION OF THE DRAWINGS

The accompanying drawings constitute a part of the description and are used to provide further understanding of the present disclosure. Such accompanying drawings illustrate the embodiments of the present disclosure which are used to describe the principles of the present disclosure. The embodiments are illustrated by way of example and not by way of limitation in the figures of the accompanying drawings in which like references indicate similar elements. It should be noted that references to “an” or “one” embodiment in this disclosure are not necessarily to the same embodiment, and they mean at least one. In the drawings:

FIG. 1 illustrates a general block diagram of a proposed system for generating simulations, in accordance with an embodiment of the present invention.

FIG. 2 illustrates the proposed system for generating simulations, in accordance with an embodiment of the present invention.

FIG. 3 illustrate steps executed by a method for generating simulations, in accordance with an embodiment of the present invention

FIG. 4 illustrates a GenAI input retrieval system, in accordance with an embodiment of the present invention.

FIG. 5 illustrates steps performed by a GenAI input retrieval system, in accordance with an embodiment of the present invention

FIG. 6 illustrates a simulation generation system, in accordance with an embodiment of the present invention.

FIG. 7 illustrates steps implemented by the simulation generation system, in accordance with an embodiment of the present invention.

FIG. 8 illustrates user input retrieval system relating to simulation generation, in accordance with an embodiment of the present invention.

### DETAILED DESCRIPTION OF THE INVENTION

The description that follows describes, illustrates and exemplifies one or more particular embodiments of the invention in accordance with its principles. This description is not provided to limit the invention to the embodiments described herein, but rather to explain and teach the principles of the invention in such a way that enables one of ordinary skill in the art to understand these principles and, with that understanding, be able to apply them to practice not only the embodiments described herein, but also other embodiments that may come to mind in accordance with these principles. The scope of the invention is intended to cover all such embodiments that may fall within the scope of the appended claims, either literally or under the doctrine of equivalents.

It should be noted that in the description and drawings, like or substantially similar elements may be labelled with the same reference numerals. However, sometimes these elements may be labelled with differing numerals, such as, for example, in cases where such labelling facilitates a clearer description. Additionally, the drawings set forth herein are not necessarily drawn to scale, and in some instances, proportions may have been exaggerated to more clearly depict certain features. Such labelling and drawing practices do not necessarily implicate an underlying substantive purpose. As stated above, the specification is intended to be taken as a whole and interpreted in accordance with the principles of the invention as taught herein and understood to one of ordinary skill in the art.

With respect to the exemplary systems, components and architecture described and illustrated herein, it should also be understood that the embodiments may be embodied by, or employed in, numerous configurations and components, including one or more systems, hardware, software, or firmware configurations or components, or any combination thereof, as understood by one of ordinary skill in the art. Accordingly, while the drawings illustrate exemplary systems including components for one or more of the embodiments contemplated herein, it should be understood that with respect to each embodiment, one or more components may not be present or necessary in the system.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” “in some embodiments,” and the like generally mean that the particular feature, structure, or characteristic following the phrase may be included in at least one embodiment of the present disclosure, and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

The present disclosure relates to a system and method for generating simulations. The simulations may be created for an enterprise or industrial establishment, where the simulation may be used for optimizing the operations or assets of the enterprise, or for predicting impact of different decisions in the outcomes of operations of the enterprise. The system generates one or more simulations based on inputs received from a user, where the inputs include at least a description, hereafter referred to as scenario description, of the simulation scenarios that the user wishes to generate using the system.

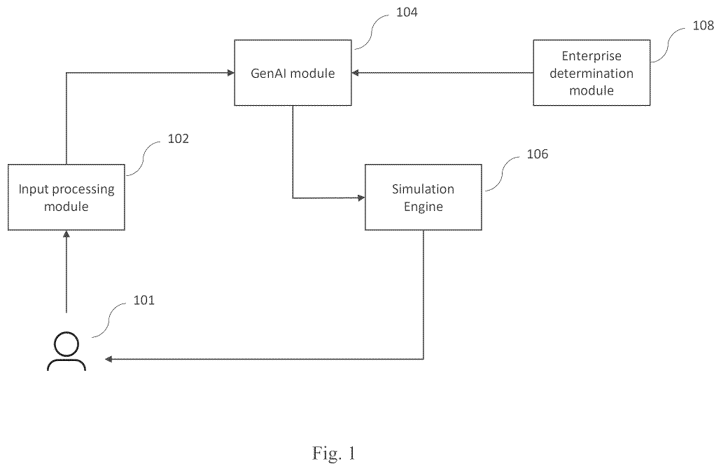

FIG. 1 illustrates a general block diagram of a proposed system for generating simulations, in accordance with an embodiment of the present invention. The system involves receiving an input from a user 101, where the input comprises at least the scenario description of a simulation scenario. The input provided by user may be processed by an input processing module 102, and the input processing module 102 may involve processing of the scenario description of input to identify one or more user requirements. The user requirements are further processed by the input processing module 102 for determining one or more parameters associated with the user requirements. The one or more parameters may be key aspects of the user requirements that are to be considered while generating data points for simulation. The one or more parameters includes at least one of type of data associated with the user requirements that is to be considered during data point generation, and role of data.

The processing of the scenario description to obtain the user requirements, and the processing of the user requirements to determine the one or more parameters, performed by the input processing module 102, is based on application of NLP (Natural Language Processing) techniques. Such processing based on NLP techniques is performed to precisely determine the user requirement from the natural language-based scenario description provided by the user 101. The one or more parameters determined by the input processing module are provided as input to a GenAI (Generative AI) module 104.

The GenAI module 104 is used for generating data points, where the data points generated by the GenAI module 104 are thereafter used for generating the one or more simulation scenarios specified by the user 101. The data points are generated by the GenAI engine of the GenAI module 104 based on the one or more parameters determined by the input processing module 104. Another input that is required by the GenAI module 104 for generating data points is the enterprise type for which the simulation is to be generated. In an embodiment, the enterprise type is identified by a enterprise module 106, and the enterprise module 106 is also used for determining other information such as data relating to the identified enterprise type. In another embodiment, the enterprise type is identified based on at least one of the simulation scenario description, a user profile, or a predefined enterprise classification.

Hence, the one or more parameters determined by the input processing module 102 and the enterprise type identified by the enterprise module 106 are provided as inputs to the GenAI module 104, based on which data points are generated by the GenAI engine. The data points generated are thereafter provided as input to a simulation module 108. A simulation engine of the simulation module 108 is used for generating one or more simulations based on the generated data points. In addition to the one or more data points, additional inputs such as the user requirement and data from knowledge database associated with the enterprise type may also be retrieved as inputs by the simulation module 108 for generating the one or more simulations corresponding to the scenario description provided by the user 101. The simulations are provided as output of the proposed system 100 to the user 101.

In an embodiment, the user 101 may provide additional inputs relating to modification or customization to be made to the simulation generated by the system. In such embodiments, the additional inputs are processed by the input processing module 102, and the new parameters generated by the input processing module 102 may be used by the GenAI module 104 to generate additional data points, or for creating a new set of data points. In case the enterprise type is also modified by the user 101, corresponding user input is processed by the enterprise module 106 for identifying the enterprise type, and is also provided as input to the GenAI module 104 for generating the additional data points. The additional data points generated by the GenAI module 104 are thereafter used by the simulation engine of the simulation module 108 to generate one or more simulations corresponding to the additional inputs provided by the user 101.

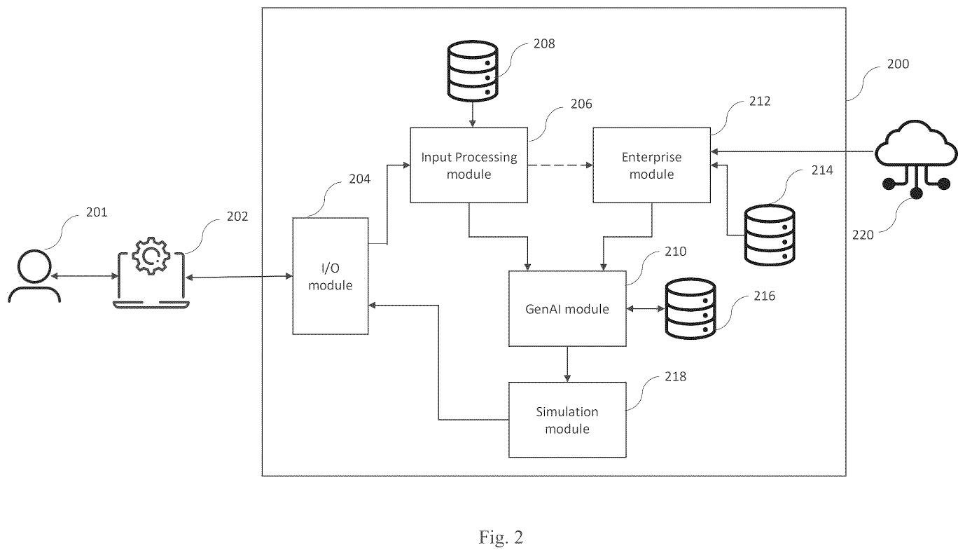

FIG. 2 illustrates a proposed system for generating simulations, in accordance with an embodiment of the present invention. The system 200 receives inputs from a user 201 via a user device 202. The user device 202 may be any device having I/O capability such as a computer, tablet, laptop, smart phone etc. The user 201 may be an employee of an enterprise for which simulations are to be generated by the system 200, or may be individuals authorized to optimize operations or assets of the enterprise, or identify different outcomes of decisions taken with respect to the operations of the enterprise.

The user input may be received from the user 201 by means of a user interface generated by an I/O module 204 of the system 200, wherein the user interface is generated at the user device 202. The user input received using the user interface includes at least a description of a scenario to be simulated, hereafter referred to as scenario description, and the scenario for which simulation is to be generated is hereafter referred to as simulation scenario. A scenario description corresponding to a simulation scenario may be provided by the user 201 as natural language-based description of the simulation scenario.

In certain embodiments, the scenario description in the user input may be retrieved as a combination of features selected by the user 201 from a list of different features provided to the user by the I/O module 204, wherein the different features may be data and prompts used for describing a simulation scenario. The combination of features selected by the user 201 is indicative of the characteristic features of the simulation scenario required by the user 201. In certain embodiments, the scenario description provided by the user 201 in the user input may be a combination of natural language-based description of the simulation scenario and selected features associated with the simulation scenario. In addition to the scenario description, the user input may include other inputs such as characteristics of the simulation to be generated. Further, the user input may also include login credentials provided by the user 201 in a login window created by the I/O module 204, where the login credentials are provided for accessing the functionalities provided by the system 200.

The user inputs retrieved by the I/O module 204 are provided to an input processing module 206 of the system 200. The input processing module 206 is used for processing the user inputs to identify one or more parameters associated with the user requirement. Herein, the one or more parameters relate to key aspects of the user requirement that are to be considered while generating data points for simulation. The one or more parameters includes at least one of type of data associated with the user requirement that is to be considered during data point generation, and role of data. The type of data relates to the different types of data required for or associated with the user requirement, and the role of data relates to the functionalities of the data in an enterprise with which the data is associated.

For example, if the user requirement determined with respect to a user input is to determine the number of lighting fixtures required in a floor of a building, one parameter may be the type of lights used in building, and values corresponding to the parameter may include ceiling light, wall light, table light etc. Another parameter may be the different roles of lighting fixtures, i.e., for reading, ambient lighting etc. While the one or more parameters determined corresponding to the user requirement includes at least one of the type of data and role of data, the input processing module may determination additional parameters corresponding to the user requirement. For instance, with regard to the above example, one of the parameters determined could be the energy consumed by different types of lights, and another parameter could be the cost of installation of different types of lights.

The operations of the input processing module 206 to identify the user requirements involves the processing of the user input received by the I/O module 204 from the user 201. Specifically, the scenario description of the user input is processed by the input processing module 206, where the scenario description is a natural language-based description of the simulation scenario, a set of different features selected by the user 201, or a combination of both. In an embodiment, the user input may be pre-processed by the input processing module 206 to reduce errors in the input provided by the user, and reduce the dimensionality of the user input. With regard to the natural language-based description of the simulation scenario, the characteristics of such a description may be based on the preference of the user 201. The natural language-based description may be a listing of keywords that the user uses to describe the simulation scenario, a brief description of the essential features of the simulation scenario, or a detailed description of the simulation scenario.

Hence, with regard to scenario description constituted by the natural language-based description of the simulation scenario, processing of such a description is performed by the input processing module 206 to precisely determine the exact user requirements of the user 201. In case of scenario description provided based on a detailed natural language-based description, such a scenario description may describe the user requirements in an ambiguous manner, or with insufficient clarity. Hence, for such a detailed scenario description, natural language processing (NLP) techniques may be implemented by the input processing module 206 for retrieving the user requirement in a precise and meaningful form that may suitable for further processing. The outcome of application of NLP techniques by the input processing module 206 may include identification of relevant keywords, a more precise definition of the user requirement, and queries suitable for further operations of the system 200.

In an embodiment where the user input retrieved by the I/O module 204 is constituted by a set of selected features, the processing performed by the input processing module 206 may include determining the user requirement based on a collective analysis of the selected features. In certain embodiments, the input processing module 206 may generate a string corresponding to the user requirement based on the selected features. In an embodiment where the scenario description provided by the user includes a natural language-based description and set of selected features, the user requirement may be identified based on performing NLP techniques on the both the natural language-based description and the set of selected features.

The user requirement determined based on processing of the user input is thereafter used by the input processing module 204 for determining the one or more parameters associated the user requirement. The one or more parameters relate to characteristic features of the user requirement which are to be identified to ensure that data points corresponding to the user requirement are generated based on all essential and relevant data associated with the user requirement. Such features may be stated or referenced in the user requirement, and in such cases, the one or more parameters may be determined based on identification of such features from the user requirement.

In cases where the features of the simulation are not directly indicated or suggested by the user requirements, the user requirement may be further processed to determine the one or more parameters associated with the user requirement. The processing of user requirement may be performed by the input processing module 206 based on pre-configured rules. Such pre-configured rules may be indicative of the steps to be performed for identifying the one or more parameters, and may be retrieved from a first database 208. In certain embodiments, the pre-configured rules may be used by the input processing module 206 for identifying keywords from the user requirement. The pre-configured rules may thereafter be used by the input processing module 206 for determining one or more parameters that are associated with each keyword. In another embodiment, the first database 208 may comprise parameters that were previously determined for the same or similar user requirement. In such embodiments, the user requirement may be processed using NLP techniques based on which parameters previously generated for similar user requirements are retrieved from the first database 208.

In certain embodiments, where features of the simulation to be generated are directly suggested or indicated in the user requirement, one or more parameters may be determined based on the identification of such features. Additionally, in such embodiments, pre-configured rules may be retrieved from the first database 208 by the input processing module 206, and the pre-configured rules may be used for further processing the user requirements for identifying parameters that are not directly suggested or indicated in the user requirements.

The one or more parameters identified from the user requirement by the input processing module 206 are provided as input to a GenAI module 210 for generation of data points for creating the simulations corresponding to the simulation scenarios required by the user 201. Before the generation of the data points, the GenAI module 210 retrieves at least an enterprise type from the enterprise module 212. The enterprise module 212 is used for determining the type of the enterprise for which the simulations are to be generated by the system 200. The enterprise type is relevant to the simulations that are to be generated, and have significant impact on the accuracy of simulations that are generated by the system 200.

In certain embodiments, the enterprise type may be determined based on the user input. The user input provided may include a selection of the enterprise with which the user is associated to, or a selection of the enterprise type. In such an embodiment, the user interface created by the I/O module 204 may include an option for selecting the enterprise type from a list of different enterprise types for which simulations can be generated by the system 200, or a field for the user 201 to enter the enterprise type. In some embodiments, the user credentials provided by the user 201 during login may be used for identifying user details, which may include details relating to the enterprise of the user 201.

In certain embodiments, prior to providing of the inputs, an enterprise classification for which the system 200 is to generate simulations is pre-defined by the user 201, or any other individual authorized to configure the operations of the system 200. Such pre-configuration may be changed by the user 201 or an authorized individual based on the type of enterprise for which the operation of the system 200 is to be performed. Such a pre-configuration classifying the enterprise for which the simulations are to be generated may be made by clicking of a button rendered at the user interface by the I/O module 204, or any other similar methods of retrieving an input. The enterprise classification may be retrieved as a selection made by the user 201 or the authorized individual from a list of different enterprise classifications for which the system 200 may be used. The enterprise classification selected is used for identifying the enterprise type for which simulations are to be generated.

In some embodiments the enterprise type may not be provided in the user input, and an enterprise classification may not be predefined for the system 200. In such embodiments, the user requirement obtained from the scenario description of the user input may be used for identifying the enterprise type that the user requirement corresponds to. Specifically, the user requirements, and the one or more parameters associated with the user requirements, determined by the input processing module 206 may be retrieved by the enterprise module 212, and the user requirements may be further processed by the enterprise module 212 for identifying the enterprise type. Such processing performed by the enterprise module 212 may involve identifying operations or assets associated with the user requirements, and determination of the enterprise types that are associated with the identified operations, or whose operations involve the identified assets.

In such embodiments, the enterprise type may also be identified by the enterprise module 212 based on determining enterprise types that were previously identified for the same or similar user requirements. Such determination may be performed based on a record of the previously identified entity types and the corresponding user requirements, which may be retrieved from a second database 214. Alternatively, in other embodiments, the second database 214 may be used for storing a record of the enterprise type associated with different keywords, and the enterprise type may be determined based on searching the second database 214 for the enterprise type corresponding to a keyword identified in the user requirement by the enterprise module 212.

One or more enterprise types may be determined by the enterprise module 212 based on one or more of the above-mentioned methods of enterprise type determination. On determining the enterprise type, the enterprise module 212 may also identify different data relating to the one or more enterprise types that may be essential for generating data points. The data identified may include data relating to the assets associated with the identified enterprise types, data relating to the operations generally performed in the enterprise types, data relating to the type of personnel employed in the enterprise types etc. Such information may be stored in the second database 214, and determined by the enterprise module 212 based on accessing the second database 214. In certain embodiments, data from one or more enterprises corresponding to the identified enterprise types may be retrieved by the enterprise module 212 by means of a server 220, where databases and repositories of one or more enterprise may be accessed via the server.

The one or more enterprise types and the data relating to the one or more enterprise types, identified by the enterprise module 212 is retrieved by the GenAI module 210 for its operation. The operation of the GenAI module 210 involves processing of the one or more parameters provided by the input processing module 206 and the inputs retrieved from the enterprise module 212. The processing of the GenAI module 210 is performed for generating prompts associated with the user requirements that are relevant to each of the identified enterprise types. The prompts generated by the GenAI module 210 for each of the identified enterprise types are thereafter provided as inputs to a GenAI engine, and the GenAI generated a plurality of data points corresponding to the prompts associated with each enterprise type.

The plurality of data points generated corresponding to each enterprise may be stored in a third database 216 by the GenAI module 210. The plurality of data points generated corresponding to each implementation of the system 200 may be stored as a single record in the third database, along with data related the implementation such as the user input, the user requirements determined from the user input, the one or more parameters associated with the user requirement, the enterprise type and data relating to the enterprise type etc. In some embodiments, the data points generated corresponding to the user input may be stored in the third database after receipt of confirmation from the user 201 that the data points are to be stored even after generation of the simulations.

The data points generated by the GenAI module 210 is thereafter provided to a simulation module 218. The data points are used for generating one or more simulations using a simulation engine of the simulation module 218, where the simulations correspond to the simulation scenarios provided as input by the user 201. In an embodiment, one or more simulations may be generated corresponding to one or more simulation scenarios provided by the user 201. In other embodiments, the input provided by the user 201 may specify the number of simulations to be generated, corresponding to which simulations are generated by the simulation module 218.

The simulations generated by the simulation module 218 are provided as output to the user 201 at the user device 202 via the I/O module 204. In instances where one or more simulations are generated by the simulation module 218, the simulations may be presented one at a time based on different criteria such as relevance of the simulation to the scenario description provided as input by the user 201, predicted accuracy of the simulation, or based on additional input received from the user 201 involving selection of the simulation the user 201 wishes to view. The simulations may also be presented to the user 201 as a combination of the different simulations generated by the user 201.

In certain instances, the user 201, on receipt of the simulations generated by the proposed system 200, may wish to make customizations or changes to one or more of the simulations. In such instances, additional input may be retrieved from the user 201, where the additional input may include a specification of the one or more simulations the user 201 wishes to modify, a description of the modifications or scenario description of the intended output simulation etc. Such additional inputs provided by the user may be processed by the input processing module 206 to identify the user requirements, and the one or more parameters associated with the identified user requirements. The one or more parameters are provided to the GenAI module for generating of data points corresponding to the one or more parameters identified from the new user requirements.

In certain embodiments, the GenAI module 210 may perform determination of whether existing data points generated in the previous implementation are sufficient for generating modified simulations corresponding to the additional input provided by the user 201. If the existing data points are identified to be sufficient, the existing data points along with the additional user requirements may be provided by the GenAI module 210 to the simulation module 218. If the existing data points are determined to be insufficient to generate simulations corresponding to the new use requirements, additional data points are generated by the GenAI engine based on the one or more parameters identified corresponding to the new user requirements. In such cases, the same enterprise type and data relating to the enterprise type used in the previous implementation is provided as input to the GenAI engine.

However, if the additional input provided by the user 201 includes inputs relating to change of the enterprise type, or a specification of a new enterprise, the new enterprise type and data relating to the new enterprise type is identified by the enterprise module 212, and provided as input the GenAI module 210. The GenAI engine of the GenAI module 210 generated a plurality of additional data points based on the one or more parameters, the enterprise type, and data relating to the enterprise.

The additional data points, along with existing data points that were used in the previous implementation for generating the simulation to be modified, are provided as input to the simulation engine of the simulation module 218, along with a query/prompt corresponding to the user requirement. The simulation engine 218 generates the modified simulation, which is thereafter provided by the simulation engine 218 as output to the I/O module 204. The I/O module 204 thereafter renders the simulation on the user interface generated at the user device 202.

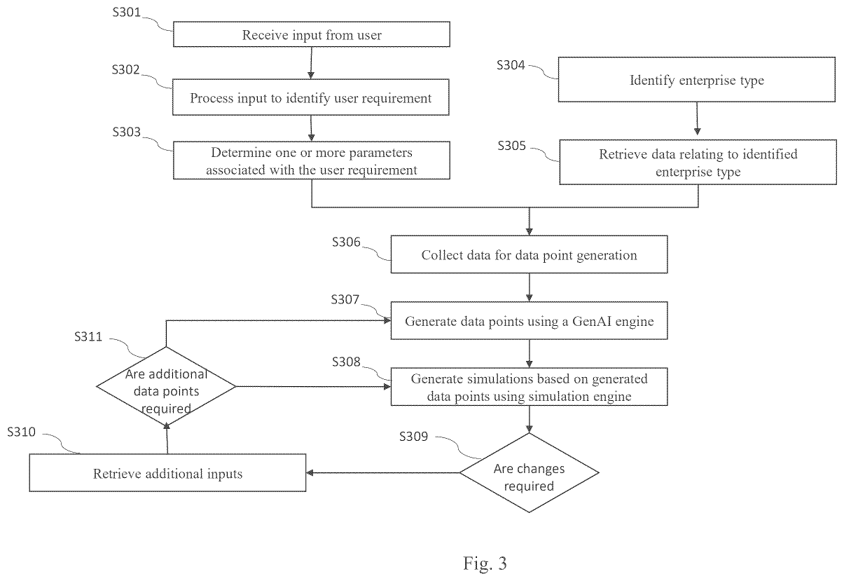

FIG. 3 illustrate steps executed by a method for generating simulations, in accordance with an embodiment of the present invention. Step S301 involves receiving an input from the user. The input includes at least a scenario description of a simulation scenario required by the user. In certain embodiments, one or more scenario description may be provided corresponding to one or more simulation scenarios to the created.

In one embodiment, the scenario description may be a natural language-based description of the scenario that the user wishes to simulate. In another embodiment, the scenario description may be a set of selected features which are chosen by the user from a plurality of features provided to the user, wherein the plurality of features relate to different characteristics of the simulation to be generated. In another embodiment, the scenario description may be a combination of a natural language-based description and a set of selected features. In a further embodiment, a selection relating enterprise classification, specification of the enterprise type, user credentials may be received. For the selection relating to enterprise classification, a list of different classifications of enterprises for which simulation can be generated may be provided to the user, and the enterprise classification corresponding to which the user selected may be retrieved. For scenario description, either one or both of the natural language-based description and set of selected features are retrieved.

At step S302, user input, especially the scenario description of the user input, is processed. The processing of the scenario description is performed for identifying the user requirement. The processing of the scenario description involves application of NLP techniques for identification of a user requirement. The scenario description retrieved in step 301 include natural language-based description, selected set of features, or a combination thereof. The scenario description received in such a manner is processed using NLP techniques for identifying a user requirement.

At step S303, the user requirement is further processed using NLP techniques for identifying one or more parameters associated with the user requirement. Generally, the user requirement suggests or indicated one or more parameters associated with the user requirement that are essential to the simulation to be generated. In such cases, the one or more parameters are identified based on processing using NLP techniques. In cases where the parameters of the user requirement are not suggested, or cannot be determined merely based on processing using NLP techniques, the user requirement may be processed using pre-defined rules. The pre-defined rules herein are steps to be performed for identifying the one or more parameters, and may be used for identifying keywords. The identified keywords are used for identifying parameters that were previously determined for the same or similar user requirement.

Step S304 involves identifying the enterprise type for the simulation to be generated. The enterprise type may be determined based on an enterprise classification selected by the user prior to providing of the scenario description. The enterprise type may also be determined based on a user input which involves either a selection of the enterprise type from a list of different enterprise types, or the enterprise with which the user is associated to. The enterprise type may also be determined based on a specification by the user describing the enterprise type. Alternatively, the enterprise type may also be determined based on user credentials provided at a login window created at the user interface of the system. In case none of such inputs are provided by the user, the enterprise type may be determined based on processing of the scenario description provided by the user, or the user requirement determined from such scenario description.

At step S305, data relating to the identified enterprise type is determined. Such data may be determined from a database associated with the enterprise type, or based on other databases and repositories that may be accessed by a server.

Step S306 involves receiving the user requirement and one or more parameters identified at step S303, and the enterprise type and data relating to enterprise type determined at step S305. Step S306 also involves identifying and accessing knowledge databases associated with the enterprise type. Step S307 involves generation of one or more data points by a GenAI engine using the inputs of step S306. The data points are generated based on the data collected at step S306, which include user requirement, one or more parameters associated with the user requirement, enterprise type, data relating to enterprise type, and knowledge database associated with the enterprise type. The one or more data points generated may be stored for future reference. At step S308, the data points generated at step S307 are used by a simulation engine for generating simulations, where the simulation engine is provided a prompt corresponding to the scenario description. Step S308 also involves providing the simulations as output to the user.

At step S309, confirmation is retrieved from the user if any modifications or changes are to be made. If the user confirms that no changes are to be made, then the operations of the system are ended. If the user confirms that modifications are to be made, additional inputs to be made are retrieved from the user at step S310. The need of additional data points is confirmed at step S311. If additional data points are not required, step S312 is performed which involves providing the additional inputs to the simulation engine to generated the simulations. If additional data points are required, the additional inputs are provided to the GenAI engine. Thereafter, simulations are generated based on steps S307 and S308.

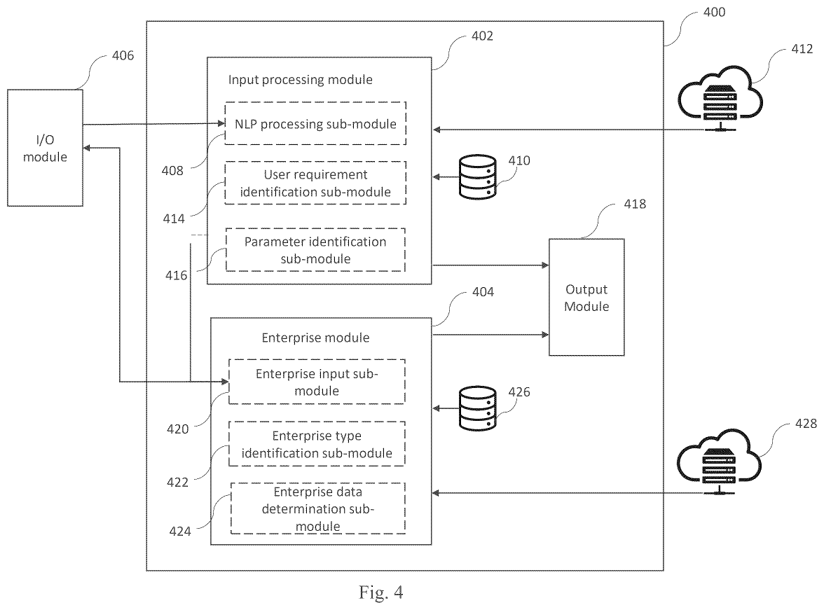

FIG. 4 illustrates a GenAI input retrieval system, in accordance with an embodiment of the present invention. The GenAI input retrieval system 400 is used for retrieving data to be provided as input to a GenAI system, where the GenAI system may be used for generating data points for creating one or more simulations. The GenAI input retrieval system 400 comprises an input processing module 402 and an enterprise module 404, where the input processing module 402 is used for determining one or more parameters associated with one or more user requirements, and the enterprise module 404 is used for identifying one or more enterprise types, and determining data relating to the one or more enterprise types.

The input processing module 402 determines one or more parameters associated with a user requirement provided in a user input received from an I/O module 406. The user input comprises a scenario description corresponding to a simulation scenario required by a user. In some instances, the user input may comprise one or more scenario descriptions corresponding to one or more simulation scenarios required by the user. The user input retrieved by the I/O module 406 is received by a pre-processing sub-module 408 of the input processing module 402. The pre-processing sub-module 408 performs pre-processing of the user input, and especially the scenario description of the user input, for generating a refined version of the scenario description. The pre-processing of the user input is performed using NLP techniques. The NLP techniques that are to be used by the pre-processing sub-module 408 may be implemented based on NLP rules retrieved from a first database 410. In certain embodiments, the NLP rules used for pre-processing the user input may be retrieved from web-based storage resources or web-based knowledge databases, and may be accessed using a web-based server 412.

The pre-processing using NLP techniques is performed by the pre-processing sub-module 408 to obtain the refined version of the scenario description provided in the user input, and such a refined scenario description can be easily processed for identifying the user requirement. Specifically, the pre-processing using NLP techniques may be used to generate a refined version of the scenario description having reduced dimensionality, and may be implemented in instances where the natural language-based scenario description provided by the user may be ambiguous and/or contain errors such as grammatical mistakes, or incomplete description.

In certain embodiments, the scenario description is provided by the user as a set of selected features. In such an embodiment, the set of selected features may be chosen from a plurality of features offered to the user. The plurality of features may be offered as natural language-based descriptions of features that are easy for the user to understand. The set of selected features, which are in natural language format, may be processed by the pre-processing sub-module 408 to generate a string or statement which precisely encapsulates the scenario description in a format that can be easily processed. The pre-processing may be performed using NLP techniques corresponding to NLP rules obtained from the first database 410, where the NLP rules used may be predefined for the different features that are offered to the users.

In some embodiments, the scenario description may be provided by the user as a combination of a natural language-based description and a set of selected features. In such an embodiment, the pre-processing sub-module 408 performs pre-processing of the natural language-based description using NLP techniques implemented using NLP rules obtained from the first database 410 or the server 412, to generate a refined version of the scenario description that it compact, precise, and without errors. The generation of the refined version for scenario description in such an embodiment is also based on the selected features, and the output of the pre-processing sub-module 410 in such an embodiment is based on combined summarization of both types of scenario descriptions. In certain embodiments, one or more scenario descriptions may be received from the I/O module 406 corresponding to one or more simulation scenarios provided by the user.

The refined version of the scenario description obtained after pre-processing is used by a user requirement identification sub-module 414 of the input processing module 402 to determine the user requirement. The user requirement is identified from the refined scenario description based on processing using NLP techniques, where the NLP techniques may be applied based on NLP rules retrieved from the first database 412. In certain embodiments, there may be one or more user requirements corresponding to one or more simulation scenarios provided by the user, in which case the processing performed by the user requirement identification sub-module 416 involves NLP-based processing of all the scenario descriptions corresponding to the one or more simulation scenarios.

In most instances, the user requirement is described in the scenario description, and a simple processing of the scenario description using NLP techniques is performed by the user requirement identification sub-module to determine the user requirement. The NLP rules for such processing may be retrieved from the first database 410, or from web-based storage resources or web-based knowledge databases accessed using the web-based server 412.

In scenarios where the user requirement is not sufficiently described in the scenario description, processing using NLP techniques may be performed by the user requirement sub-module 414 for identifying key words in the scenario description. The key words may be used for searching the first database 410 for identifying similar scenario descriptions for which user requirement was identified. The searching may be performed with respect to a first record maintained in the first database 410, where the first record contains entries of all user requirements identified corresponding to previously received scenario descriptions.

In one embodiment, a previously identified user requirement corresponding to a scenario description with highest number of common or similar keywords may be used as reference by the user requirement sub-module 414 for generating a string. The generated string corresponds to the user requirement determined by the user requirement sub-module 414 based on reference to the previously identified user requirement. The string is provided as query to the user by means of the I/O module 406, where the query may request confirmation from the user regarding the accuracy of the generated query in capturing the user requirement. The confirmation may be received as an input via the I/O module 406. If the query is confirmed by the user as being incorrect, then the user requirement sub-module 414 may request additional inputs from the user relating to user requirements or generate a new query to be confirmed by the user.

Thus, the user requirement identification sub-module 414 identifies the user requirement from the scenario description provided by a user. The scenario description provided by a user, and the identified user requirement may be stored in the first record of the first database 410 for future reference. In certain embodiments, one or more user requirements may be identified by the user requirement identification sub-module corresponding to the scenario description. The identified user requirement is thereafter used by the parameter identification sub-module 416 for determining one or more parameters associated with the user requirement. The one or more parameters associated with a user requirement includes at least one of type of data and role of data, where type of data relates to different types of data associated with the user requirement, and role of data relates to the functionality of each type of data.

The user requirement is processed by the parameter identification sub-module 416 to identify the one or more parameters. The processing by the parameter identification sub-module 416 involves application of NLP techniques to determine the one or more parameters, as such processing is performed in instances where the user requirement provides indication or suggestion regarding the one or more parameters. The NLP techniques may be implemented by the parameter identification sub-module 416 by accessing corresponding NLP rules from a first database 410. In certain embodiments, the steps relating to the parameter identification that is to be performed by the parameter identification sub-module 416 is determined based on pre-defined rules. The one or more parameters may be identified based on pre-defined rules retrieved from the first database 412, where the pre-defined rules may be configured by an authorized individual prior to the implementation of the GenAI input retrieval system 400. The pre-defined rules may include instructions for identifying different parameters generally associated with different user requirements.

In embodiments where the one or more parameters cannot be determined based on processing of the user requirement using NLP techniques, the user requirement may be processed to identify keywords. An indication regarding possible keywords in a user requirement, or keywords commonly used in different user requirements, may be provided in the pre-defined rules. The keywords of the user requirement may be identified based on using NLP techniques and the pre-defined rules. On identification of the keywords, one or more parameters associated with each keyword may be identified by the parameter identification sub-module 418. The one or more parameters may be identified based on pre-configured rules which define the different parameters associated with different keywords. In certain embodiments, data relating to possible parameters corresponding to the identified keywords may be obtained from web-based storage resources or web-based knowledge databases accessed using the web-based server 412. The data obtained from the web-based server 412 may be used for determining the one or more parameters corresponding to the identified keywords.

In certain embodiments, a second record maintained in the first database 412, containing entries of one or more parameters identified corresponding to different keywords and different user requirements, may be referenced by the parameter identification sub-module 418. On referencing the second record, the parameter identification sub-module 418 may identify the one or more parameters that were previously determined corresponding to the same or similar user requirement. In the absence of entries corresponding to the same or similar user requirement, one or more parameters identified corresponding to the same or similar keywords are identified. The determination of one or more parameters performed by the parameter identification sub-module 416 may include a combination of the different approaches described above.

The one or more parameters corresponding to the user requirement may be stored as entries in the second record maintained in the first database. Further, the one or more parameters identified by the different methods employed by the parameter identification sub-module 416 corresponding to the user requirement obtained from the user input may be combined to obtain a final set of parameters, and such a final set of parameters is provided to an output module 418. The output module 418 is used for providing inputs to a simulation generation system for the generation of data points. The inputs provided to a simulation generation system also includes at least one enterprise type with respect to which the simulations are to be generated, and may also include data relating to the enterprise type.

The enterprise type, and the data relating to the enterprise type, is provided to the output module 418 by an enterprise module 404. The enterprise module 404 comprises an enterprise input sub-module 420, an enterprise type identification sub-module 422, and an enterprise data retrieval sub-module 424. The enterprise input sub-module 420 is used for retrieving input provided by the user relating to the enterprise type. The input relating to the enterprise type may be a configuration input provided by the user prior to providing scenario description, where the configuration input involves selection of an enterprise classification by the user. Such a configuration may be made by the user in scenarios where simulations are to generated with respect to a constant enterprise classification. The configuration may also be made by the user for restricting the simulations to a specific classification of enterprises. In such an instance, the enterprise classification selected by the user may be retrieved by the enterprise input sub-module 420 using the I/O module 406.

In certain scenarios, the enterprise type may be referenced or indicated by the user in the user input. For instance, the user input may include a selection of the enterprise with which the user is associated to, or a selection of the enterprise type. Such a selection may be enabled by the I/O module 408 by providing the user the option to select the enterprise type from a list of different enterprise types. The list of different enterprise types may be a list of enterprise types for which simulations can be generated. Alternatively, the enterprise type may be retrieved as an input to a field created by the I/O module 408 for entering the enterprise type.

In one embodiment, the enterprise type may be identified from the user credentials provided by the user. The user credentials may be retrieved by enterprise input sub-module 420 using the I/O module 406. In instances where neither enterprise classification nor user credentials are provided by the users, the enterprise input sub-module 420 retrieves the user requirement and the one or more parameters generated by the input processing module 402. The user requirement and the one or more parameters obtained from the user input are indicative of the requirements of the user with regard to the simulation, and may be used for identifying the type of enterprise with respect to which the user requires simulations to be generated. Such an identification of enterprise type can be made based on identifying operations or assets associated with the user requirement, where the operations or assets may be identified from the one or more parameter. The identification of the operations and assets associated with a user requirement may be used for identifying the enterprise type in which such operations are performed, or such assets are used.

In embodiments where the input processing module 402 and the enterprise module 404 are implemented simultaneously, the user requirement and the one or more parameters may not be accessible to the enterprise input sub-module 420. In such embodiments, the scenario description provided by the user may be retrieved by the enterprise input sub-module 420 using the I/O module 406, and processing of the scenario description based on NLP techniques may be performed to identify if any enterprise type is suggested therein.

Such user input retrieved by the enterprise input sub-module 420 may be processed by the enterprise type identification sub-module 422 for identifying the enterprise type. The processing of the user input received from the enterprise input sub-module 420 may comprise different types of inputs. If the retrieved user input includes an enterprise classification selected by the user, the enterprise type corresponding to the selected enterprise classification may be determined based on an enterprise classification record stored in a second database 426. The enterprise classification record may be created prior to the implementation of the GenAI input retrieval system 400 by an authorized individual having knowledge of the different enterprise types. In such an enterprise classification record, each entry of enterprise classification may have one or more corresponding enterprise types. On receipt of user input having enterprise classification, the enterprise type identification sub-module 422 identifies one or more corresponding enterprise types based on referencing of the enterprise classification record.

In instances where user input retrieved by the enterprise input sub-module 420 comprises a selection of the enterprise type, the enterprise type is determined by the enterprise type identification sub-module 422 based on the selection. In instance where user input comprises a specification of the enterprise type entered in a field generated by the I/O module 406, an NLP processing of the specification is performed by the enterprise type identification sub-module 422 for determining the enterprise type. Such a determination may be made with reference to a list of possible enterprise types, where such a list may be stored in the second database 426. In certain embodiments, the processing of the specification of the enterprise type by NLP techniques may involve identification of one or more keywords, and searching the list for a similar enterprise type.

In cases where the user input retrieved by the enterprise type input sub-module 420 includes user credentials, the user credentials may be processed by the enterprise type identification sub-module 422 to determine data associated with the user, including the enterprise with which the user is associated. In cases where none of the above inputs are retrieved by the enterprise type input sub-module 420, the enterprise type identification sub-module 420 performs processing of the user requirement and the one or more parameters associated with the user requirement, both of which are obtained from the input processing module 402. The user requirement may be processed using NLP techniques for identifying an enterprise with respect to which the user requirement is associated. Such an identification may be made with reference to the one or more parameters associated with the user requirement. On identification of the enterprise, the corresponding enterprise type may be determined by the enterprise type identification sub-module 422.

In instances where user requirement and the one or more parameters are not determined, the scenario description provided in the user input may be processed using NLP techniques for identifying any enterprise type indicated therein. In one embodiment, the scenario description may be processed using NLP techniques to identify one or more keywords. The one or more keywords may be used for searching entries in the enterprise type record stored in the second database 426 for identifying corresponding enterprise types. In some embodiments, one or more enterprise types may be determined corresponding to the user input.

The enterprise type identified by the enterprise type identification sub-module 422 is thereafter used by the enterprise data determination sub-module 424 for determining data relating to enterprise type that may be relevant for generating data points. The data identified may include data relating to the assets associated with the identified enterprise types, data relating to the operations generally performed in the enterprise types, data relating to the type of personnel employed in the enterprise types etc. The identified enterprise type may be used for determining the different enterprises associated with such enterprise types, and retrieving data relating to such enterprises. The data relating to the enterprise type may be retrieved databases associated with such enterprises which may be accessible to the enterprise data determination sub-module 424. The data relating to the enterprise may also be retrieved from web-based storage resources or web-based knowledge databases accessed using the web-based server 428, where such web-based storage resources or web-based knowledge databases are used for storing different types of data relating to different enterprise types and enterprises.

The enterprise type, and the data relating to the enterprise type, determined by the enterprise module 404 is provided to the output module 418. The output module 418 provides the user requirement and the one or more parameters determined by the input processing module 402 and the above data as input to a GenAI engine for generation of data points which may be used by a simulation engine for generating one or more simulations. In certain embodiments, the output module 418 may generated an export file that may be shared with a system used for generating data points and creating simulations. In some embodiments, all the data received by the output module 418 may be saved a database for future reference. In such an embodiment, the data may be saved as entries in a record, where each entry corresponds to a scenario description and comprises data generated by the input processing module 402 and enterprise module 404.

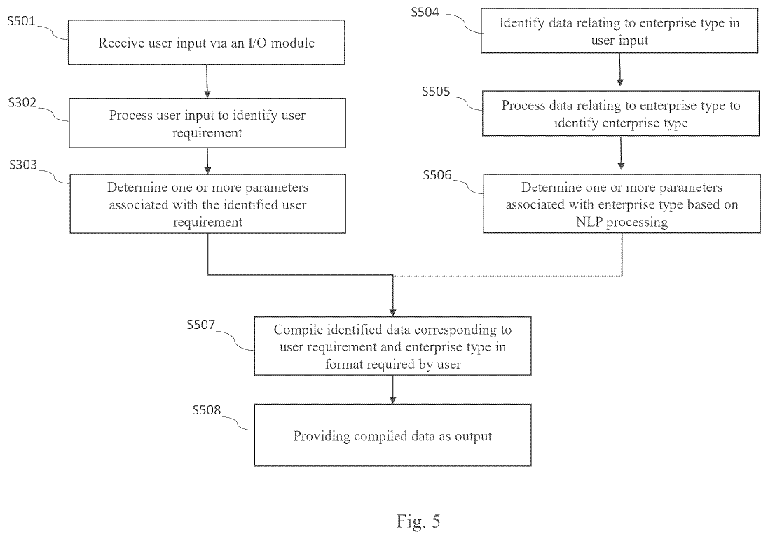

FIG. 5 illustrates steps performed by a GenAI input retrieval system, in accordance with an embodiment of the present invention. Step S501 involves receiving the user input, and pre-processing the user input based on NLP techniques, and the NLP techniques for pre-processing may be retrieved from a first database. Such pre-processing is performed to obtain a more refined version of the scenario description. Step S502 involves identifying the user requirement from the refined scenario description received from step S501. The processing of the scenario description is done using NLP techniques, and such processing may involve identification of keywords of the scenario description.

Step S503 involves determination of one or more parameters associated with the identified user requirement. The determination of one or more parameters may be performed based on processing of the user requirement using NLP techniques. Such processing using NLP techniques may also be based on pre-defined rules retrieved from the first database, where such pre-defined rules are configured by an authorized individual. The pre-defined rules retrieved herein may include instructions or data relating to identifying different parameters associated with different user requirements. Additionally, processing of user requirement for determining one or more parameters may also include identification of keywords, and determining parameters associated with the keywords.

Step S504 involves retrieving of user inputs relating to enterprise type. Such a step involves identifying the aspects of the user input relating to enterprise type, and retrieving such inputs for processing to determine enterprise type. Step S505 involves processing of such inputs to determine an enterprise type for which the simulations are to be generated. The processing of the inputs to determine enterprise type may include NLP-based processing, identification of keywords, searching in records comprising list of previous identified enterprise types etc.

Step S506 involves determination of data relating to the enterprise type. Such determination involves accessing databases associated with the user to identify any database comprising data relating to the enterprise type. The determination also includes identifying other databases and knowledge databases associated with the enterprise type from the databases that are accessible to the system. The databases identified may also include databases accessible via a web-based server.

Step S507 involves compilation of the inputs received corresponding to steps S501 to S503 and inputs received from steps S504 to S506 in a format required by the user. The format required by the user may be as a stream of data, or as an export file that may be used by different systems for generating data points. Step S508 involves providing the data compiled at step S507 as an output.

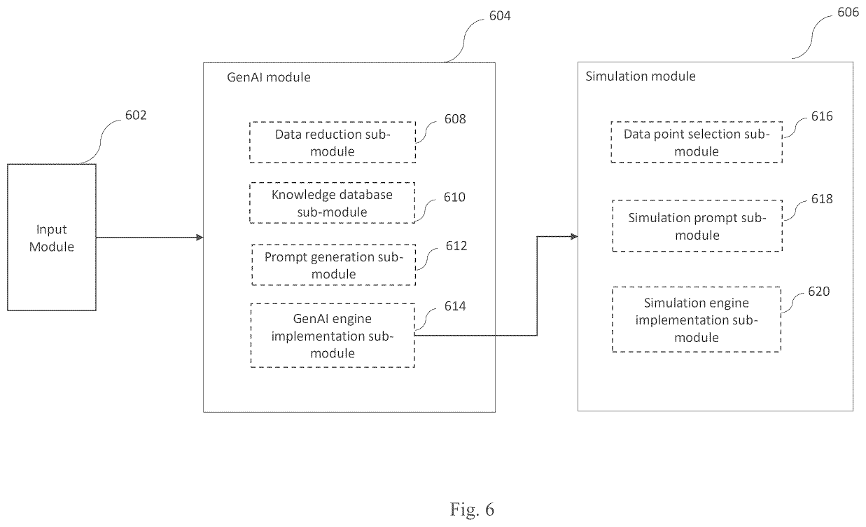

FIG. 6 illustrates a simulation generation system, in accordance with an embodiment of the present invention. The simulation generation system 600 is used for generating data points based on a received input, and creating one or more simulations based on the generated data points. The received input relates to user requirement of a user with regard to simulations to be generated, and enterprise type with respect to which simulation is to be generated. In an embodiment, the input may be received as an output stream from a GenAI input retrieval system. In another embodiment, the input may be received as an export file generated by the GenAI input retrieval system. The input from the GenAI input retrieval system may be retrieved by an input module 602 of the simulation generation system 600.

The input received by input module 602 is provided to a GenAI module 604 of the simulation generation system 600, where the GenAI module 604 is used for generating data points corresponding to the input, where the data points are generated using a GenAI engine. The data points generated by the GenAI module 604 is thereafter used by the simulation module 606 of the simulation generation system 600, where the simulation module 606 is used for generating one or more simulations corresponding to the scenario description and the simulation scenario. The one or more simulations are generated using a simulation engine of the simulation module 606, and the simulations generated therein are provided as output of the simulation generation system 600.

The GenAI module 604 is used for generating data points from the input using a GenAI engine. The generation of data points from the input is performed using a data reduction sub-module 608, a knowledge database sub-module 610, a prompt generation sub-module 612, and a GenAI engine implementation sub-module 614. The data reduction sub-module 608 is used for generating a data set that may be used as input for the GenAI engine. The input received from the input module 602 consists of at least one user requirement and one or more parameters, where the user requirement is determined based on the scenario description of the simulation to be generated and the one or more parameters are key aspects associated with the user requirement. The input also comprises at least one enterprise type and data relating to the enterprise type, where the enterprise type indicates the type of enterprise for which the simulation is to be generated.

The above-mentioned input may comprise duplicate values or data, and may be too voluminous to be provided as input to the GenAI engine. The input to be provided to the GenAI engine, hereafter referred to as GenAI input, may be obtained based on processing the received input to obtain a compact and clean data set. The data reduction sub-module 608 created such a data set to be used as GenAI input, based on reducing the dimensionality of input. The processing performed by the data reduction sub-module 608 may include removal of incomplete, removal of duplicate data or values etc. Further, in some embodiments, the processing also involves selecting only data from the input that is relevant to both user requirement and the enterprise type. Hence, any data relating to the enterprise type that is not associated with the user requirement may be ignored. Similarly, any parameter associated with the user requirement but not associated with the enterprise type is not considered.

The data set obtained after such processing and dimensionality reduction is taken as the GenAI input. In addition to the GenAI input, the knowledge databases associated with the enterprise type of the input received by the input module 602 is determined and provided as input to the GenAI engine. The determination of the knowledge database is performed by the knowledge database sub-module 610. The operation of the knowledge database sub-module 610 involves identification of the different databases associated with the enterprise type that are accessible to the simulation generation system 600. Such an operation of the knowledge database sub-module 610 may involve identifying the databases used by a user of the simulation generation system 600, and determining the databases that are relevant to the enterprise type. The operation may also involve identifying the web-based databases associated with the enterprise type.

The operation of the GenAI engine may be based on a prompt provided to the GenAI engine. The prompt generation sub-module 612 may be used for generating the prompt, and the prompt may be generated based on the user requirement and the enterprise type. The generation of prompt may also be configured based on the scenario description provided by a user corresponding to the simulation scenario required by the user. The GenAI implementation sub-module 614 is used for generating data points based on the prompt generated by the prompt generation sub-module 612. The operation of the GenAI implementation sub-module 614 involves executing a GenAI engine using the generated prompt, where the GenAI engine is provided access to user requirement, the one or more parameters associated with the user requirement, the enterprise type, data relating to the enterprise type, and the knowledge databases identified by the knowledge database sub-module 610. Based on such inputs, the GenAI engine generates one or more data points. In one embodiment, the GenAI engine may be trained based on knowledge database of different enterprise types and different user requirements prior to the implementation of the simulation generation system 600.

After the generation of the data points using the GenAI implementation sub-module 614, the data points are provided as input to the simulation module 606. A data point selection sub-module 616 of the simulation module 606 is used for identifying the data points to be used for generating one or more simulations corresponding to the scenario description. In certain embodiments, all the data points received from the GenAI module 604 may be selected by the data point selection sub-module 616. In another embodiment, only the data points relevant to the scenario description are selected. In another embodiment, the pre-defined rules for selection of data points may be used by the data point selection sub-module 616 to select data points. Such a selection of data points may be performed in scenarios where a huge volume of data points are generated by the GenAI module 604, or where only most relevant data points are to be used for generating the simulations.

A simulation prompt sub-module 618 of the simulation module 606 may be used for generating a prompt for executing the simulation engine. The prompt is generated by the simulation prompt sub-module 618 based on the simulation scenario, and scenario description provided by the user. A simulation engine implementation sub-module 620 is used for implementing the simulation engine based on the prompt generated by the simulation prompt sub-module 618 using the data points selected by the data point selection sub-module 616. In an embodiment, one or more prompts may be generated by the simulation prompt sub-module 618 corresponding to one or more simulation scenarios. In such an embodiment, one or more simulations are generated by the simulation engine implementation sub-module 620 corresponding to the one or more prompts. The one or more simulations generated by the simulation module 606 are provided as output to the user.

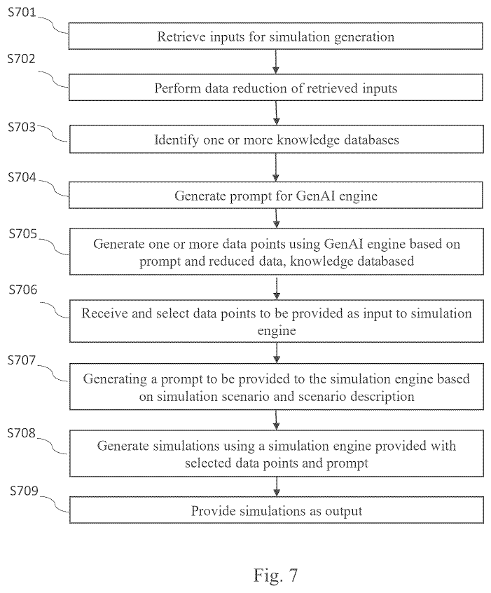

FIG. 7 illustrates steps implemented by the simulation generation system, in accordance with an embodiment of the present invention. Step S701 involves retrieving inputs comprising the user requirement, one or more parameters associated with the user requirement, enterprise type, and the data relating to enterprise type, which may be generated by a system used for generating inputs for genAI engine based on scenario description provided by a user. Step S702 involves performing reduction of the data received, so as to ensure only relevant data are considered during data point generation. The reduction of data may include removal of duplicate values, removal of incomplete or erroneous data. Further, the reduction of data may also include selection of only data corresponding to both the enterprise type and the user requirement, thereby removing irrelevant data.

Step S703 involves identifying one or more knowledge databases comprising information or data associated with the enterprise type. The one or more knowledge databases may be identified from a plurality of databases, where such knowledge databases comprise data associated with the enterprise type, or data relating to domain of the enterprise type. Step S704 involves generating a prompt for a GenAI engine, where the prompt is generated based on the user requirement, the one or more parameters associated with the user requirement, and the enterprise type.

Step S705 involves executing a GenAI engine with the prompt generated in step S704, where the GenAI engine has access to data which include the scenario description, the user requirement, the one or more parameters associated with the user requirement, the enterprise type, the data relating to the enterprise type, and the one or more knowledge databased identified. One or more data points are generated by the GenAI engine based on such implementation.

Step S706 involves selection of the data points for generating the simulations from the data points generated at step S705. The data points generated at step S705 may be vast in number, and not all the data points may be required for generating the simulation. The selection of data points for generating the simulations may be based on identifying the most relevant data points for the simulation, or based on pre-defined rules for selection. Step S707 involves generating a prompt to be provided to the simulation engine, and such a prompt is generated based on the simulation scenario and scenario description provided by the user. Step S708 involves executing the simulation engine based on the prompt generated at step S707, and using the data point selected in step S706. One or more simulations may be generated if one or more prompts were determined in step S707. Step S709 involves providing as output the simulations generated at step S708.

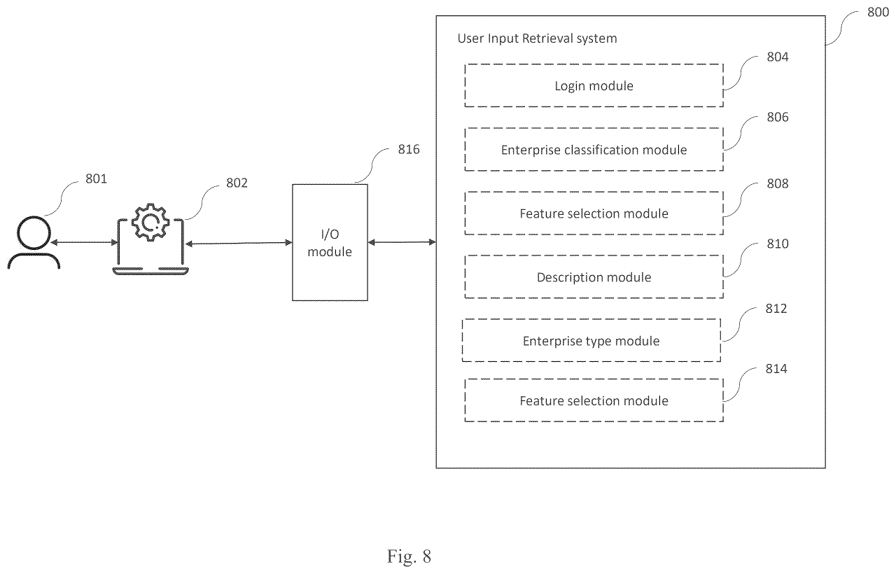

FIG. 8 illustrates user input retrieval system relating to simulation generation, in accordance with an embodiment of the present invention. The user input retrieval system 800 comprises a plurality of modules used for enabling retrieval of different types of input from a user 801 via a user device 802, where the different types of input collectively constitute a user input for generating simulations. The modules of the user input retrieval system 800 include a login module 804, an enterprise classification module 806, a feature selection module 808, a description module 810, an enterprise type module 812, and a suggestion module 814.

The login module 804 is used for generating a login window at the user interface created by a I/O module 816, and retrieving login credentials of the user 801. The login module 804 may generated the login window prior to the implementation of other modules of the user input retrieval system, and may use the login window as authentication of the user. The enterprise classification module 806 is used for providing a plurality of different enterprise classifications to the user 801, and receives the enterprise classification selected by the user 801. The different enterprise classifications may be predefined, and the selection of the enterprise classification is made by the user 801 to limit the simulations to the selected enterprise classification.

The feature selection module 808 is used for providing a plurality of features as option to the user 801 using the I/O module 816, wherein the user 801 may select one or more of the features associated with the simulation scenario that the user 801 wishes to generate. The plurality of features may be defined in natural language format that is easily comprehendible to the user 801, and the selected features are retrieved by the feature selection module 808 using the I/O module 816. A description module 810 is also used for retrieving the scenario description from the user 801, wherein the description module 810 generates a field for the user to provide or fill in the scenario description using the I/O module 816, and retrieves the description provided by the user 801. In embodiments where the user provides responses that are retrieved by both the feature selection module 808 and the description module 810, the scenario description is determined based on a combination of both inputs.

The entity type module 812 may be used by the user input retrieval system 800 for retrieving from the user information relating to the enterprise type. Information regarding the enterprise type may be provided by the user as a natural language description of the enterprise type, or as a selection of features the user believes to be associated with the entity type. The selection of features may be made from a plurality of features provided by the entity type module 812, where the plurality of features is provided based on the different features that may be used to define a enterprise type.

The suggestion module 814 is used for providing suggestions to the user 801 based on a plurality of factors. One factor based on which suggestions are provided may be based on history of use by the user 801, based on which suggestions are provided based on commonly performed simulations. Such suggestions may relate to the enterprise the user is associated with, the user role in the enterprise etc. Another factor based on which suggestions are provided may be the simulations that are generally requested by other users having a similar role as the user, or associated with the same enterprise as the user. Such suggestions may be provided as ready-made scenario descriptions. In another embodiment, based on one or more features selected corresponding to implementation of the feature selection module 808, suggestions may be provided by the suggestion module 814, based on prior scenario descriptions having the same features.

An embodiment of the invention may be an article of manufacture in which a machine-readable medium (such as microelectronic memory) has stored thereon instructions which program one or more data processing components (generically referred to here as a “processor”) to perform the operations described above. In other embodiments, some of these operations might be performed by specific hardware components that contain hardwired logic (e.g., dedicated digital filter blocks and state machines). Those operations might alternatively be performed by any combination of programmed data processing components and fixed hardwired circuit components. Also, although the discussion focuses on uplink medium control with respect to frame aggregation, it is contemplated that control of other types of messages are applicable.

In the above description, for purposes of explanation, numerous specific details are set forth in order to provide a thorough understanding of the present systems and methods. It will be apparent the systems and methods may be practiced without these specific details. Reference in the specification to “an example” or similar language means that a particular feature, structure, or characteristic described in connection with that example is included as described, but may not be included in other examples.

An interface may be used to provide input or fetch output from the system. The interface may be implemented as a Command Line Interface (CLI), Graphical User Interface (GUI). Further, Application Programming Interfaces (APIs) may also be used for remotely interacting with edge systems and cloud servers.

A processor may include one or more general purpose processors (e.g., INTEL® or Advanced Micro Devices® (AMD) microprocessors) and/or one or more special purpose processors (e.g., digital signal processors or Xilinx® System On Chip (SOC) Field Programmable Gate Array (FPGA) processor), MIPS/ARM-class processor, a microprocessor, a digital signal processor, an application specific integrated circuit, a microcontroller, a state machine, or any type of programmable logic array.

A memory may include, but is no limited to, non-transitory machine-readable storage devices such as hard drives, magnetic tape, floppy diskettes, optical disks, Compact Disc Read-Only Memories (CD-ROMs), and magneto-optical disks, semiconductor memories, such as ROMs, Random Access Memories (RAMs), Programmable Read-Only Memories (PROMs), Erasable PROMs (EPROMs), Electrically Erasable PROMs (EEPROMs), flash memory, magnetic or optical cards, or other type of media/machine-readable medium suitable for storing electronic instructions.

The terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

Any combination of the above features and functionalities may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set as claimed in claims that issue from this application, in the specific form in which such claims issue, including any subsequent correction.

We claim:

1. A method for generating simulation data, comprising:
receiving a user input to execute one or more simulation scenarios, wherein the user input includes at least one scenario description;
processing the at least one scenario description to determine user requirements;
determining one or more parameters associated with the user requirements;
identifying at least one enterprise type associated with the user requirements, wherein the enterprise type is identified based on at least one of, the scenario description, a user profile, or a predefined enterprise classification;
providing the one or more parameters and the at least one identified enterprise type to a GenAI engine;
generating, by the GenAI engine, one or more data points based on each parameter corresponding to each identified enterprise type; and
providing the one or more data points to a simulation engine for executing the one or more simulation scenarios.

2. The method of claim 1, wherein the one or more parameters includes at least one of type of data, role of data.

3. The method of claim 1, wherein the scenario description provided in the user input is processed by Natural Language Processing (NLP) technique.

4. The method of claim 1, further comprising:
accessing at least one knowledge database associated with the at least one identified enterprise type.

5. The method of claim 1, further comprising:
receiving at least one modification in the scenario description; and
identifying one or more modified parameters based on modification in the scenario description; and
providing the one or more modified parameters and the at least one identified enterprise type to the GenAI engine.

6. The method of claim 1, further comprising:
selectively providing generated data points to the simulation engine based on user selection.

7. The method of claim 1, further comprising:
storing the one or more generated data points for the at least one identified enterprise type in a database.

8. The method of claim 7, further comprising:
identifying if the one or more data points associated with the one or more parameters is present in the database; and
generating one or more additional data points, based on identification that the one or more data points are not present in the database.

9. A system for migration of actions between software applications, the system comprising:
a processor; and
a memory coupled with the processor, wherein the memory stores program instructions configured to:
receive a user input to execute one or more simulation scenarios, wherein the user input includes at least one scenario description;
process the at least one scenario description to determine user requirements;
determine one or more parameters associated with the user requirements;
identify at least one enterprise type associated with the user requirements, wherein the enterprise type is identified based on at least one of, the scenario description, a user profile, or a predefined enterprise classification;
provide the one or more parameters and the at least one identified enterprise type to a GenAI engine;
generate, by the GenAI engine, one or more data points based on each parameter corresponding to each identified enterprise type; and
provide the one or more data points to a simulation engine for executing the one or more simulation scenarios.

10. The system of claim 9, wherein the one or more parameters includes at least one of type of data, role of data.

11. The system of claim 9, wherein the scenario description provided in the user input is processed by Natural Language Processing (NLP) technique 12. The system of claim 9, wherein the program instructions are further configured to:
access at least one knowledge database associated with the at least one identified enterprise type.

13. The system of claim 9, wherein the program instructions are further configured to:
receive at least one modification in the scenario description; and
identify at least one or more modified parameters based on modification in the scenario description; and
provide the one or more modified parameters and the at least one identified enterprise type to the GenAI engine.

14. The system as claimed in claim 9, wherein the program instructions are further configured to:
selectively provide generated data points to the simulation engine based on user selection.

15. The system as claimed in claim 9, wherein the program instructions are further configured to:
store the one or more generated data points for the at least one identified enterprise type in a database.

16. The system as claimed in claim 15, wherein the program instructions are further configured to:
identify if the one or more data points associated with the one or more parameters is present in the database; and
generate one or more additional data points, based on identification that the one or more data points are not present in the database.

17. A non-transitory computer-readable storage medium comprising computer program code for execution by one or more processors of an apparatus, the computer program code configured to:
receive a user input to execute one or more simulation scenarios, wherein the user input includes at least one scenario description;
process the at least one scenario description to determine user requirements;
determine one or more parameters associated with the user requirements;
identify at least one enterprise type associated with the user requirements, wherein the enterprise type is identified based on at least one of, the scenario description, a user profile, or a predefined enterprise classification;
provide the one or more parameters and the at least one identified enterprise type to a GenAI engine;
generate, by the GenAI engine, one or more data points based on each parameter corresponding to each identified enterprise type; and
provide the one or more data points to a simulation engine for executing the one or more simulation scenarios.

18. The non-transitory computer-readable storage medium of claim 17, wherein the computer program code is further configured to:
access at least one knowledge database associated with the at least one identified enterprise type.

19. The non-transitory computer-readable storage medium of claim 17, wherein the computer program code is further configured to:
receive at least one modification in the scenario description; and
identify at least one or more modified parameters based on modification in the scenario description; and
provide the one or more modified parameters and the at least one identified enterprise type to the GenAI engine.

20. The non-transitory computer-readable storage medium of claim 17, wherein the computer program code is further configured to:
selectively provide generated data points to the simulation engine based on user selection.
